(19) United States
(12) Patent Application Publication
(10) Pub. No.: US 2005/0044150 A1
(43) Pub. Date: Feb. 24, 2005

(54) Intelligent mail server apparatus

(75) Inventors: David Louis Kaminsky, Chapel Hill, NC (US); David M. Ogle, Cary, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/635,598

(22) Filed: Aug. 6, 2003

(51) Int. Cl. G06F 15/16

(52) U.S. Cl. 709/206

(57) ABSTRACT

A system, method and apparatus for intelligently handing an impairment to the delivery of e-mail messages to intended recipients in a mail delivery system. The method can include storing received e-mail messages prior to forwarding the messages to inboxes of respective mail servers. An impairment to delivering the messages to the inboxes can be detected and senders for selected ones of the messages can be identified. Subsequently, a notification of the impairment can be forwarded to the identified senders.

### BACKGROUND OF THE INVENTION

1. Statement of the Technical Field

The present invention relates to the field of network administration and more particularly to detecting electronic mail delivery failures in a mail delivery system.

2. Description of the Related Art

Electronic mail (hereinafter “e-mail”) has proven to be the principal application of the Internet age. Without the ubiquity of e-mail, many question whether the Internet would have developed beyond a mere scientific experiment. Remarkably, e-mail has formed the basis of person to person communication despite the disparate devices individuals use to access e-mail over the Internet. In this regard, several elements are required to enable the exchange of e-mail between users: a common e-mail format, a common e-mail exchange protocol, a collection of interconnected e-mail servers, and e-mail clients through which users can originate and terminate e-mail messages.

Generally speaking, the conventional e-mail server receives e-mail messages from a mail gateway which can queue incoming messages as the messages enter the domain of the mail server. Once the mail server has received an incoming message from the gateway, it is the responsibility of the e-mail server to store the e-mail on behalf of the intended recipient can hold the e-mail until such time as the intended recipient can retrieve the e-mail message through an associated e-mail client. Notably, from the perspective of the sender of the e-mail message, the e-mail message seems to have been successfully delivered once the e-mail message reaches the e-mail gateway.

Oftentimes, the sender of an e-mail message requires more than an assumption that an e-mail message has arrived at its intended destination. Consequently, the common e-mail protocol permits a sender of an e-mail message to request a confirmation that the e-mail has not only been delivered, but also that an e-mail message has been opened and read. Indeed, when the e-mail server associated with the intended recipient fails to connect with the e-mail server of the sender in order to deliver the e-mail message, the sender can be notified of the non-responsiveness of the recipient e-mail server.

Presently, though an e-mail gateway within the appropriate domain can receive and queue an e-mail on behalf of an intended recipient, a technical deficiency in the mail server can prevent the delivery of an e-mail message to a recipient. For instance, an entire internal e-mail system outage can inhibit the delivery of all e-mail messages to internal e-mail clients, though the e-mail gateway visible to the remainder of the Internet can remain operable, collecting and storing messages for the benefit of the internal e-mail servers who ultimately will be able to retrieve the messages once the internal system outage has been resolved. Unfortunately, however, the sender of the e-mail message will remain unaware of the inability of the recipient to receive the e-mail message in a timely manner.

Many have addressed the possible inability of a mail server to deliver e-mail messages in a timely manner. For example, in U.S. patent Publication No. 2002/0161706 A1, Ed Brinskele et al. teach the third-party detection of a network outage and the notification of a customer of the third-party of such outage. Similarly, in U.S. patent Publication No. 2002/0107958 A1, David D. Faraldo II discloses the notification of a set of pre-designated persons of a detected state change. U.S. patent Publication No. 2001/0044841 A1 yet further teaches the notification of another system when the a monitored site fails in its operation. Finally, Japanese Patent No. JP2001086152 to Ichijoj Hiroshi includes disclosure directed to mail server failover in which a mail exchange routes mail to a selected primary mail server and re-routes e-mail to a secondary mail server upon detecting a fault in the primary server.

Nevertheless in each instance, the sender of the e-mail will remain oblivious to the failure of the e-mail server to deliver an e-mail message to a targeted recipient. At best, a third party can detect a fault in the gateway itself. Of course, none of the foregoing cited references disclose detecting a fault in the delivery path between the recipient gateway and the e-mail client of the targeted recipient. Thus, the sender of an e-mail message continues to lack assurances that an e-mail message has arrived safely at its intended destination in a timely manner. From the perspective of the sender, the failure of the targeted recipient to respond to an e-mail can only indicate that the recipient has chosen not to respond—an incorrect assumption on the part of the sender where a transmission failure has inhibited the delivery of the e-mail message.

### SUMMARY OF THE INVENTION

The present invention addresses the deficiencies of the art in respect to handling impediments to the delivery of e-mail and provides a novel and non-obvious method, system and apparatus for handling the delivery of e-mail to the inboxes of respective intended recipients when an impairment to the delivery of the e-mail messages has become apparent. In accordance with the present invention, an intelligent e-mail gateway can include a queue configured to store received messages forwarded by senders over a network to a mail server coupled to the gateway and associated with corresponding intended recipients.

Importantly, a notification manager can be coupled to the gateway and the queue and configured to notify selected ones of the senders when delivery to the intended recipients has become impaired. In this regard, message generation logic can be programmed to format notifications for the senders. The notifications can indicate at least one of an estimated down time of the mail server; an estimated time when the delivery will no longer be impaired; and an alternate e-mail address with which the selected ones of the senders can retransmit the messages to corresponding intended recipients. Moreover, the selected ones of the senders can include at least one of the senders who has been determined to be priority senders; and senders who have labeled their respective messages urgent.

A method for intelligently handing an impairment to the delivery of e-mail messages to intended recipients in a mail delivery system queuing received e-mail messages prior to forwarding the messages to inboxes of respective mail servers. An impairment to delivering the messages to the inboxes can be detected and senders for selected ones of the messages can be identified. Subsequently, a notification of the impairment can be forwarded to the identified senders.

The detecting step can include the step of consulting a data store of state information for selected ones of the respective mail servers to recall an already identified impairment. Alternatively, the detecting step can include the step of probing selected ones of the respective mail servers to detect the impairment. In yet a further alternative embodiment, the detecting step can include both attempting to transmit the messages, and concluding the existence of an impaired state when the attempt fails.

The identifying step can include the step of identifying only priority senders. Alternatively, the identifying step can include the step of identifying only senders of urgent messages. The forwarding step, by comparison, can include formatting a detailed notification describing a nature of the impairment, and forwarding the detailed notification to the identified senders. More particularly, the forwarding step can include formatting a notification including both a statement of the impairment and an estimate of when normal mail delivery service can resume, and forwarding the detailed notification to the identified senders. Alternatively, the forwarding step can include, for each of the identified senders, formatting a notification having both a statement of the impairment and an alternate e-mail address for use in retransmitting a corresponding one of the messages, and forwarding the detailed notification to the identified senders.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an electronic mail delivery system which has been configured in accordance with the present invention; and,

FIG. 2 is a flow chart illustrating a process for managing a delivery fault in the electronic mail delivery system of FIG. 1.

### DETAILED DESCRIPTION OF THE PREFERRED EMBODIMENTS

The present invention is an intelligent mail gateway configured to notify a sender of an electronic message when a message transmitted by the sender through the gateway cannot be delivered promptly to its intended recipient. The gateway can include a message store, such as a queue or a list, for storing incoming messages prior to routing the messages in the message store to appropriate mail servers. In this regard, the gateway can be coupled to one or more mail servers, or the gateway can be a component portion of a mail server which remains visible to external mail servers. In either case, when an e-mail has been stored pending delivery within the gateway, it can be determined whether the mail can be forwarded on to the recipient. If a delay is imminent due to a temporary or permanent outage or impairment in the path between the gateway and the recipient, an e-mail can be returned to the sender with suitable information.

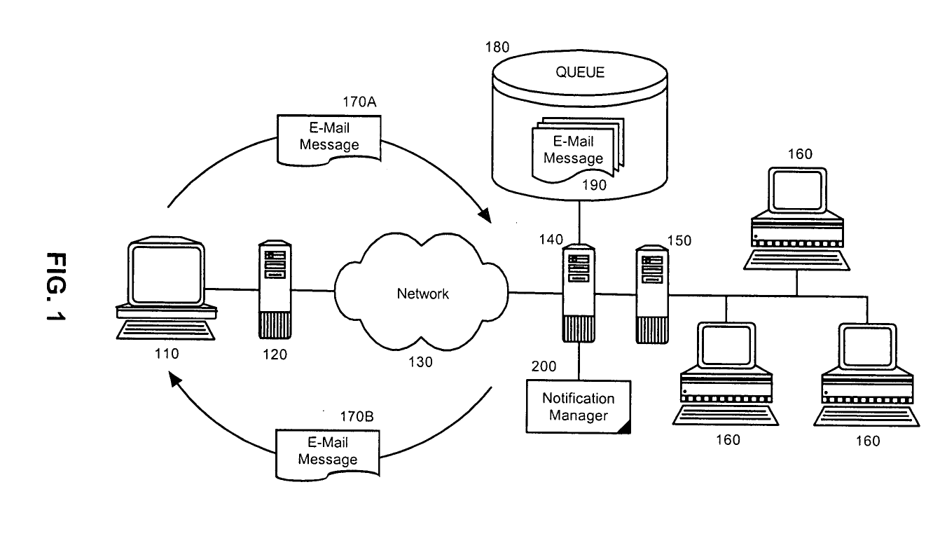

FIG. 1 is a schematic illustration of an electronic mail delivery system which has been configured in accordance with the present invention. The system can include a multiplicity of e-mail recipients 160 coupled to at least one mail server 150 (only one mail server illustrated for purposes of simplicity). The mail server 150, in turn can be coupled to a network 130 through a mail gateway 140. The network can include a private Intranet or a public Internet, for example. Notably, the mail gateway 140 can be a formalized computing device which stands separate from the mail server 150. In this regard, the mail gateway 140 can include a message store such as a list (not shown), or a queue 180 for storing received e-mail messages 190 prior to forwarding the same to a selected mail server 150. Alternatively, the mail gateway 140 can be an integrated component of the mail server 150. In either case, the mail gateway 140 can receive and store e-mail messages 170A prior to their receipt in the mail server 150.

Importantly, a notification manager 200 can be included with the mail gateway 140. The notification manager 200 can recognize downstream obstructions or impairments to the delivery of a received e-mail message 170A. In this regard, an impairment can be unplanned, such as a failure, or planned, such as a system component upgrade. Impairments can also include, but are not limited to a downed mail server, bandwidth restrictions, failed routing, and the like. Impairments are not limited to perpetual outages. Rather, impairments can include mere delays or latencies which otherwise can delay the timely delivery of the message 170A to any one of the recipients 160. In this regard, as the mail gateway 140 resides at the choke point of the delivery path within the network, the mail gateway 140 is best positioned to detect a downstream impairment. The detection can be passive by way of inferring an outage through the non-responsive behavior of a downstream component such as the mail server 150, or the detection can be active by way of probing for an outage. Of course, if the outage is planned, the notification manager 200 can be informed by an administrator.

In either case, responsive to detecting a downstream impairment, the notification manager 200 can create a notification e-mail message 170B for transmission to one or more of the senders 110 (only one sender illustrated for purposes of simplicity, such single sender 110 having a coupling to a mail delivery system 120) of the e-mail messages 190 residing in the queue 180. The notification can state that the message 170A has been received in the mail gateway 140, but that an outage, whether temporary or otherwise, has prevented the delivery of the message 170A to the intended recipient 160. In this way, the sender 110 will understand that the non-responsive nature of the recipient bears relation to the failure of the message 170A to arrive with the recipient.

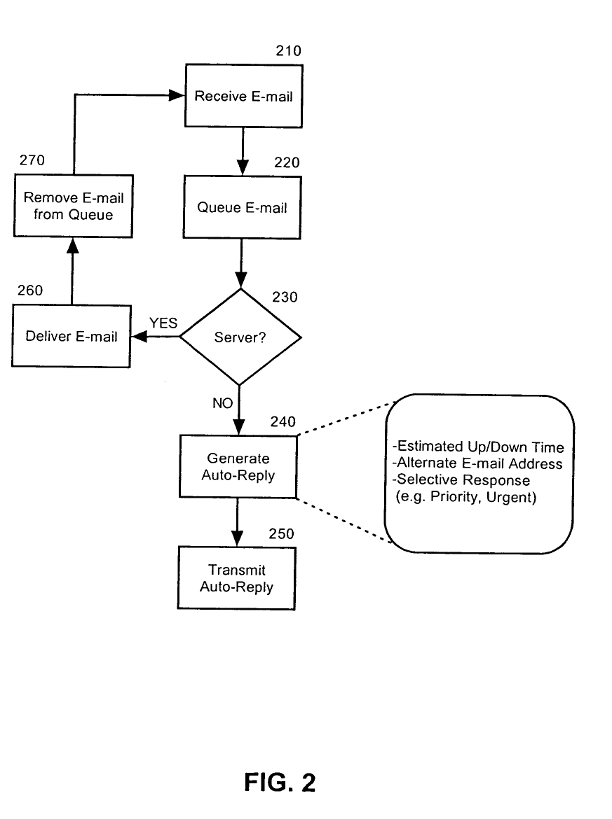

A preferred process for managing impairments to the delivery of e-mail messages in a mail delivery system is illustrated in FIG. 2. Beginning in block 210, an e-mail message can be received in the mail gateway. In block 220, the received e-mail message can be queued for routing to a mail server for placement in the inbox of the intended recipient. In decision block 230, the e-mail message can be retrieved from the queue and an attempt to forward the e-mail message to a suitable mail server can be performed. In this regard, either an actual delivery of the e-mail message can be attempted, or it can be determined without an attempt whether the path is clear to the inbox of the e-mail server, and whether the e-mail server is operational. More specifically, it may already be known to the gateway from a previous attempt that an impairment exists. Alternatively, the path can be probed to ensure a clear path.

In either case, in decision block 230, if the path is clear to the inbox of the mail server, in block 260 the e-mail message can be routed to the inbox of the mail server and in block 270 the e-mail message can be removed from the queue. Otherwise, if the path is not clear to the inbox of the mail server, in block 240 a message can be generated to indicate the non-delivery of the e-mail message. Importantly, the content of the generated message can range from a mere notification that the message had not been delivered in a timely manner, to a more detailed message which indicates the estimated down time of the delivery system, the estimated time when the system will resume nominal operations, an alternative e-mail address for reaching the recipient, etc. Information regarding the duration of the outage can optionally be extracted from a problem tracking component coupled to the notification manager, or such information can be stored in the notification manager. While a notification can be created for each message in the queue, in an enhanced aspect of the invention, a notification may be created selectively for only a subset of the senders who have sent messages residing in the queue. For instance, a notification may be created only for priority senders, or those senders who have marked their messages as urgent. In any case, in block 250, the created message can be forwarded to the sender.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information proecessing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. An intelligent electronic mail (e-mail) gateway comprising:
a message store configured to store received messages forwarded by senders over a network to a mail server coupled to the e-mail gateway and associated with corresponding intended recipients; and,
a notification manager coupled both to the gateway and said message store, said manager having a configuration for notifying selected ones of said senders when delivery to said intended recipients has become impaired.

2. The gateway of claim 1, further comprising message generation logic programmed to format notifications for said senders which indicates at least one of an estimated down time of said mail server; an estimated time when said delivery will no longer be impaired; and an alternate e-mail address with which said selected ones of said senders can retransmit said messages to corresponding intended recipients.

3. The gateway of claim 1, wherein said selected ones of said senders comprises at least one of senders who have been determined to be priority senders and senders who have labeled their respective messages urgent.

4. The gateway of claim 1, wherein said message store is a queue.

5. A method for intelligently handing an impairment to the delivery of e-mail messages to intended recipients in a mail delivery system, the method comprising the steps of:
storing received e-mail messages prior to forwarding said messages to inboxes of respective mail servers;
detecting an impairment to delivering said messages to said inboxes;
identifying senders for selected ones of said messages; and,
forwarding a notification of said impairment to said identified senders.

6. The method of claim 5, wherein said storing step comprises the step of queuing received e-mail messages prior to forwarding said messages to inboxes of respective mail servers.

7. The method of claim 5, wherein said detecting step comprises the step of consulting a data store of state information for selected ones of said respective mail servers to recall an already identified impairment.

8. The method of claim 5, wherein said detecting step comprises the step of probing selected ones of said respective mail servers to detect said impairment.

9. The method of claim 5, wherein said detecting step comprises the steps of:
attempting to transmit said messages; and,
concluding the existence of an impaired state when said attempt fails.

10. The method of claim 5, wherein said step of identifying comprises the step of identifying only priority senders.

11. The method of claim 5, wherein said step of identifying comprises the step of identifying only senders of urgent messages.

12. The method of claim 5, wherein said forwarding step comprises the steps of:
formatting a detailed notification describing a nature of said impairment; and,
forwarding said detailed notification to said identified senders.

13. The method of claim 5, wherein said forwarding step comprises the steps of:
formatting a notification comprising both a statement of said impairment and an estimate of when normal mail delivery service can resume; and,
forwarding said detailed notification to said identified senders.

14. The method of claim 5, wherein said forwarding step comprises the steps of:
for each of said identified senders, formatting a notification comprising both a statement of said impairment and an alternate e-mail address for use in retransmitting a corresponding one of said messages; and,
forwarding said detailed notification to said identified senders.

15. A machine readable storage having stored thereon a computer program for intelligently handing an impairment to the delivery of e-mail messages to intended recipients in a mail delivery system, the computer program comprising a routine set of instructions for causing the machine to perform the steps of:
storing received e-mail messages prior to forwarding said messages to inboxes of respective mail servers;
detecting an impairment to delivering said messages to said inboxes;
identifying senders for selected ones of said messages; and,
forwarding a notification of said impairment to said identified senders.

16. The machine readable storage of claim 15, wherein said storing step comprises the step of queuing received e-mail messages prior to forwarding said messages to inboxes of respective mail servers.

17. The machine readable storage of claim 15, wherein said detecting step comprises the step of consulting a data store of state information for selected ones of said respective mail servers to recall an already identified impairment.

18. The machine readable storage of claim 15, wherein said detecting step comprises the step of probing selected ones of said respective mail servers to detect said impairment.

19. The machine readable storage of claim 15, wherein said detecting step comprises the steps of: attempting to transmit said messages; and,
concluding the existence of an impaired state when said attempt fails.

20. The machine readable storage of claim 15, wherein said step of identifying comprises the step of identifying only priority senders.

21. The machine readable storage of claim 15, wherein said step of identifying comprises the step of identifying only senders of urgent messages.

22. The machine readable storage of claim 15, wherein said forwarding step comprises the steps of:
formatting a detailed notification describing a nature of said impairment; and,
forwarding said detailed notification to said identified senders.

23. The machine readable storage of claim 15, wherein said forwarding step comprises the steps of:
formatting a notification comprising both a statement of said impairment and an estimate of when normal mail delivery service can resume; and,
forwarding said detailed notification to said identified senders.

24. The machine readable storage of claim 15, wherein said forwarding step comprises the steps of:
for each of said identified senders, formatting a notification comprising both a statement of said impairment and an alternate e-mail address for use in retransmitting a corresponding one of said messages; and,
forwarding said detailed notification to said identified senders.
